(19) United States
(12) Patent Application Publication
(10) Pub. No.: US 2026/0363838 A1
(43) Pub. Date: Nov. 19, 2026

(54) DENTAL DEVICES, SYSTEMS AND METHODS MAKING THEREOF

(71) Applicant: Hua Zhu, LLC, Lebanon, NJ (US)

(72) Inventors: Hua ZHU, Clinton, NJ (US); Bree ZHANG, Clinton, NJ (US)

(21) Appl. No.: 19/676,773

(22) Filed: May 13, 2026

Related U.S. Application Data
(60) Provisional application No. 63/805,966, filed on May 14, 2025.

(51) Int. Cl. A61C 13/10; A61C 13/107

(52) U.S. Cl. CPC A61C 13/1013; A61C 13/0001

(57) ABSTRACT

Provided herein are certain arch devices for preparing full or partial denture for a subject. The disclosed arch device comprises a stock tray comprising two or more teeth. Each of at least two of the two or more teeth comprises a hook. Also provided are the systems of the arch devices and methods of making the arch devices.

### CROSS-REFERENCE TO RELATED APPLICATIONS

This application claims the benefit of U.S. Provisional Application No. 63/805,966, filed May 14, 2025, which application is incorporated herein by reference in its entirety

### BACKGROUND OF THE INVENTION

Traditionally, the denture-making process involves multiple steps, thus, requires the subject to pay multiple visits to the dental office and the dental office to exchange models multiple times with a lab. During the first visit, preliminary impressions of the arches of the subject are taken using stock trays which are used to create preliminary models. Custom trays are then crafted in the lab based on the preliminary models. During the second visit, these custom trays are utilized to obtain more precise final impressions of the subject together with border molding. The final impressions are sent to the lab, where lab technicians subsequently develop wax rims based on the final models derived from these final impressions. During the third visit, the wax rims are employed to record tooth position and jaw relationship information. The lab technician will then use the information collected to make articulate models and set individual teeth in wax. In the fourth visit, the dentist asks the subject to try the wax dentures and may record additional information for the lab to make necessary adjustments and finalize the dentures. In the fifth visit, the final dentures may be adjusted and delivered to the subject.

In dental offices equipped with intraoral scanners, surface information of the arches of the subject can be scanned during the first visit and sent to the lab. Lab technicians use the received data to design and print digital occlusal rims, or prototype dentures with estimated teeth positions. Lab technicians can also use the received data to print models and make traditional wax rims. The printed occlusal rims, printed prototype dentures or traditional wax rims can be provided to the dentists for collecting teeth and jaw relationship information during the second visit. The information collected will be used to set up teeth digitally and to print try-in dentures. During the third visit, the subjects’ phonetics, esthetics, chewing movements, contacts, and other essential aspects will be evaluated using the try-in dentures. Additional information or modifications may be sent to the lab to make necessary adjustments and generate final dentures. During the fourth visit, the final dentures may be adjusted and delivered to the subject.

### SUMMARY OF THE INVENTION

Provided herein is an innovative device that integrates final impressions and the recording of important tooth and occlusion information in a single dental visit, thus eliminating the need for multiple preliminary visits. When combined with 3-dimensional (3D) intraoral scanning, the device may enhance the accuracy of the denture base. By adding motion tracking tags and integrating 3D facial scanning and software, the device may enable the recording of lower jaw movements and creating a virtual articulator. This device may be turned into temporary dentures or permanent dentures. It can also be used to make temporary crowns or bridges. This device may simplify the process, ensuring that the creation of dentures that are both functional and aesthetically pleasing for the subjects.

In one aspect of the present disclosure, provided herein is a stock tray comprising a polymeric material, wherein:
the stock tray comprises an arch base comprising:
   a first surface configured to face a dental arch, and
   a second surface comprising two or more teeth positioned on a peripheral of the arch base;
the arch base, the two or more teeth, or both, comprise one or more retention mechanisms,
the two or more teeth comprise a first tooth and a second tooth,
the first tooth comprises a first hook, and
the second tooth comprises a second hook.

In some embodiments, the stock tray further comprises a plurality of breakable strips between adjacent teeth of the two or more teeth, between a tooth of the two or more teeth and the arch base, or between one section of the arch base and an adjacent section of the arch base. In some embodiments, the stock tray is an upper stock tray, wherein: the upper stock tray comprises a first arch base comprising: a first surface configured to face an upper dental arch, and a second surface comprising two or more upper teeth positioned on a peripheral of the first arch base, the first arch base, the two or more upper teeth, or both, comprise one or more upper retention mechanisms, the two or more upper teeth comprise a first upper tooth and a second upper tooth, the first upper tooth comprises a first upper hook, and the second upper tooth comprises a second upper hook. In some embodiments, the stock tray is a lower stock tray, wherein: the lower stock tray comprises a second arch base comprising: a third surface configured to face a lower dental arch; and a fourth surface comprising two or more lower teeth positioned on a peripheral of the second arch base; the second arch base, the two or more lower teeth, or both, comprise one or more lower retention mechanisms, the two or more lower teeth comprise a first lower tooth and a second lower tooth, the first lower tooth comprises a first lower hook, and the second lower tooth comprises a second lower hook. In some embodiments, the polymeric material is plastics. In some embodiments, the polymeric material is thermosetting plastics. In some embodiments, the polymeric material is thermoplastics with glass transition temperature of at least 100 ºC. In some embodiments, the polymeric material comprises polyoxymethylene (POM), polyphenylene sulfide (PPS), polyphenylsulfone (PPSU), polysulfone (PSU), polyetheretherketone (PEEK), polybutylene terephthalate (PBT), polyamide-imide (PAI), polyvinyl chloride (PVC), polycarbonate, polylactide, acrylic, phenolic, acrylonitrile butadiene, styrene, fiberglass, or nylon, or a combination thereof. In some embodiments, the polymeric material comprises (meth)acrylate polymer, epoxy, silicone, polyester, polyurethane, or thiol-ene polymer. In some embodiments, the polymeric material comprises urethane (meth)acrylate polymer, polyalkylene oxide di(meth)acrylate, alkane diol di(meth)acrylate, aliphatic (meth)acrylate, or silicone (meth)acrylate. In some embodiments, the polymeric material comprises urethane (meth)acrylate polymer comprising an alkyl group, a polyalkylene group, a polyalkylene oxide group, an aryl group, a polycarbonate group, a polyester group, or a polyamide group, or a combination thereof. In some embodiments, the stock tray further comprises a filler. In some embodiments, the filler is independently glass, quartz, silica, zirconia oxide, alumina oxide, TiO₂ or a combination thereof. In some embodiments, the one or more retention mechanisms comprise a hole, a hollow frustum, a protrusion, or a combination thereof. In some embodiments, the one or more retention mechanisms comprise the hole, and wherein the hole is on the arch base or the one or more teeth. In some embodiments, the one or more retention mechanisms comprise the hollow frustum on the first surface of the stock tray, and wherein the hollow frustum is on the arch base or the one or more teeth. In some embodiments, the one or more retention mechanisms comprises one or more hollow frustum, where each of the one or more hollow frustum is part of a tooth of one or more teeth on the stock tray, where each of the one or more hollow frustum together with the corresponding tooth of the one or more teeth on the stock tray is a tooth-shaped hollow shell. In some embodiments, the one or more retention mechanisms comprise the protrusion on the first surface of the stock tray, and wherein the protrusion is on the arch base or the one or more teeth. In some embodiments, at least one breakable strip of the plurality of breakable strips is between the adjacent teeth. In some embodiments, at least one breakable strip of the plurality of breakable strips is between the tooth and the arch base. In some embodiments, at least one breakable strip of the plurality of breakable strips is between the one section of the arch base and the adjacent section of the arch base. In some embodiments, each of the first hook, the second hook, the first upper hook, the second upper hook, the first lower hook, and the second lower hook is configured to be breakable from the first tooth, the second tooth, the first upper tooth, the second upper tooth, the first lower tooth, and the second lower tooth, respectively.

In another aspect of the present disclosure, provided herein is an assembly comprising an upper stock tray and a lower stock tray, wherein:
the upper stock tray comprises a first arch base comprising:
   a first surface configured to face an upper dental arch, and
   a second surface comprising two or more upper teeth positioned on a peripheral of the first arch base,
the first arch base, the two or more upper teeth, or both, comprise one or more upper retention mechanisms,
the two or more upper teeth comprise a first upper tooth and a second upper tooth,
the first upper tooth comprises a first upper hook,
the second upper tooth comprises a second upper hook,
the lower stock tray comprises a second arch base comprising:
   a third surface configured to face a lower dental arch; and
   a fourth surface comprising two or more lower teeth positioned on a peripheral of the second arch base;
the second arch base, the two or more lower teeth, or both, comprise one or more lower retention mechanisms,
the two or more lower teeth comprise a first lower tooth and a second lower tooth,
the first lower tooth comprises a first lower hook,
the second lower tooth comprises a second lower hook,
the first upper hook and the first lower hook is tied with a first elastomer, a first rubber band,
a first strap, a first ring, or a first string, and
the second upper hook and the second lower hook are tied with a second elastomer, a second rubber band, a second strap, a second ring, or a second string.

In some embodiments of the assembly, the two or more upper teeth comprise an additional upper tooth, the additional upper tooth comprises an additional upper hook, the two or more lower teeth comprise an additional lower tooth, the additional lower tooth comprises an additional lower hook, and the additional upper hook and the additional lower hook are tied with an additional elastomer, an additional rubber band, an additional strap, an additional ring, or an additional string.. In some embodiments of the assembly, the two or more upper teeth further comprise a third upper tooth and a fourth upper tooth, the third upper tooth comprises a third upper hook, the fourth upper tooth comprises a fourth upper hook, the two or more lower teeth further comprise a third lower tooth and a fourth lower tooth, the third lower tooth comprises a third lower hook, the fourth lower tooth comprises a fourth lower hook, the third upper hook and the third lower hook is tied with a third elastomer, a third rubber band, a third strap, a third ring, or a third string, and the fourth upper hook and the fourth lower hook is tied with a fourth elastomer, a fourth rubber band, a fourth strap, a fourth ring, or a fourth string. In some embodiments of the assembly, each of the first upper hook, the second upper hook, the additional upper hook, the third upper hook, the fourth upper hook, the first lower hook, the second lower hook, the additional lower hook, the third lower hook, and the fourth lower hook is configured to be breakable from the first upper tooth, the second upper tooth, the additional upper tooth, the third upper tooth, the fourth upper tooth, the first lower tooth, the second lower tooth, the additional lower tooth, the third lower tooth, and the fourth lower tooth, respectively.

In still another aspect of the present disclosure, provided herein is a method for forming an arch device for a subject, comprising:
(a) providing a pair of stock trays of any one disclosed herein, wherein the pair of stock trays comprise a maxillary stock tray and a mandibular stock tray;
(b) placing a first portion of a moldable material on a first surface of the maxillary stock tray, and spreading the first portion of the moldable material over at least a part of the first surface;
(c) adjusting the maxillary stock tray in a mouth of the subject; and
(d) curing the first portion of the moldable material on the maxillary stock tray, thereby making a maxillary custom tray and recording the correct teeth position;
(e) using the maxillary custom tray to get final impression with the correct teeth position,
(e) adjusting the mandibular stock tray;
(f) secure the maxillary final impression and the mandibular stock tray together with an elastomer, a rubber band, a strap, a ring, or a string or a hand;
(g) placing a second portion of the moldable material on a second surface of the mandibular stock tray, and spreading the second portion of the moldable material over at least a part of the second surface;
(h) seating the maxillary final impression tied with the mandibular stock tray in the mouth of the subject completely;
(j) guide the subject to close into centric relation at preset VDO; and
(k) curing the second portion of the moldable material on the mandibular stock tray, thereby forming the mandibular custom tray with the teeth in the correct position and the correct jaw relationship.

In some embodiments, the method further comprising: (l) using the mandibular custom tray to get final impression with the correct mandibular teeth and jaw relationship.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a picture of an example lower stock tray.

FIG. 2 shows an illustration of the example lower stock tray in FIG. 1.

FIG. 3 shows a picture of an example upper stock tray.

FIG. 4 shows an illustration of the example upper stock tray in FIG. 3.

FIG. 5 shows a picture of an example assembly of the lower stock tray in FIG. 1 and the upper stock tray in FIG. 3.

FIG. 6 shows an illustration of the example assembly in FIG. 5.

FIG. 7 shows another illustration of an example upper stock tray.

FIG. 8 shows an illustration of a cross section of the example upper stock tray in FIG. 7.

FIG. 9A shows an illustration of a cross section of an example retention mechanism. FIG. 9B shows an illustration of another cross section of another example retention mechanism. FIG. 9C shows an illustration of still another cross section of still another example retention mechanism.

FIG. 10 shows an illustration of an example of breakable strips between adjacent teeth.

### DETAILED DESCRIPTION OF THE INVENTION

The terminology used herein is for the purpose of describing particular cases only and is not intended to be limiting. As used herein, the singular forms “a”, “an” and “the” are generally intended to include the plural forms as well, unless the context clearly indicates otherwise. Furthermore, to the extent that the terms “including”, “includes”, “having”, “has”, “with”, or variants thereof generally refer to either the detailed description and/or the claims, such terms can be intended to be inclusive in a manner similar to the term “comprising”.

As used herein, the term “or” generally refers to a nonexclusive or, such that “A or B” includes “A but not B,” “B but not A,” and “A and B,” unless otherwise indicated.

As used herein, the term “about” or “approximately” generally refers to within an acceptable error range for the particular value as determined by one of ordinary skill in the art, which may depend in part on how the value is measured or determined, i.e., the limitations of the measurement system. For example, the term “about” as used herein indicates the value of a given quantity varies by +/−10% of the value, or optionally +/−5% of the value, or in some embodiments, by +/−1% of the value so described. Alternatively, “about” can mean a range of up to 20%, up to 10%, up to 5%, or up to 1% of a given value. Where particular values may be described in the application and claims, unless otherwise stated the term “about” meaning within an acceptable error range for the particular value should be assumed. Also, where ranges and/or subranges of values are provided, the ranges and/or subranges can include the endpoints of the ranges and/or subranges.

As used herein, when disclosing percentage or range of percentage, these percentages are with respect to weight per volume unless stated otherwise.

The term “substantially” as used herein can refer to a value approaching 100% of a given value. For example, an active agent that is “substantially localized” in an organ can indicate that about 90% by weight of an active agent, salt, or metabolite can be present in an organ relative to a total amount of an active agent, salt, or metabolite. In some cases, the term can refer to an amount that can be at least about 90%, 91%, 92%, 93%, 94%, 95%, 96%, 97%, 98%, 99%, 99.9%, or 99.99% of a total amount. In some cases, the term can refer to an amount that can be about 100% of a total amount.

The term “denture” as used herein can refer to full (or complete) denture or partial denture according to whether all the teeth in the dental arch or part of the teeth in the arch are replaced by the denture.

The term “full denture” or “complete denture” can refer to any denture that replaces all the teeth in the dental arch. It includes but not limits to interim complete denture, temporary complete denture, immediate complete denture, interim tooth supported complete overdenture, interim implant supported complete overdenture, interim implant supported complete denture, complete denture, tooth supported complete overdenture, implant supported complete overdenture, implant supported complete denture, implant supported bridge,

The term “partial denture” can refer to any denture that replaces one or more, but not all the teeth in the dental arch. There is still at least one subject’s own tooth left in the dental arch. It includes but not limits to interim partial denture, temporary partial denture, immediate partial denture, interim tooth supported partial overdenture, interim implant supported partial overdenture, interim implant supported partial denture, temporary implant supported bridge, partial denture, tooth supported partial overdenture, implant supported partial overdenture, implant supported partial denture, and implant supported bridge.

The term “denture” as used herein can also refer to temporary denture or permanent denture according to how much time the denture will be used.

The term “temporary denture” as used herein can refer to any denture that is intended to be used for less than a year, including but not limiting to interim complete denture, temporary complete denture, immediate complete denture, interim tooth supported complete overdenture, interim implant supported complete overdenture, interim implant supported complete denture, interim partial denture, temporary partial denture, immediate partial denture, interim tooth supported partial overdenture, interim implant supported partial overdenture, temporary implant supported bridge. It provides subjects with time to wait for the tissue healing, provide temporary aesthetics and function, and/or to wait for the lab to make a more defined or better-quality denture, and/or to wait for other reasons.

The term “permanent denture” as used herein can refer to any denture that is intended to be used for more than a year, including but not limiting to complete denture, tooth supported complete overdenture, implant supported complete overdenture, implant supported complete denture, partial denture, tooth supported partial overdenture, implant supported partial overdenture, implant supported partial denture, implant supported bridge. The permanent denture may be more durable, better in quality, and may last for a longer time.

The arch devices and methods disclosed herein include teeth position information and final impression for making full or partial denture. The methods disclosed herein allow a subject in need of a full or partial denture to be provided with crucial data required for making a denture in one dental office visit.

Traditional denture requires the subject to visit the dental office 3 to 5 times, with the whole process lasting weeks and sending models/information to the lab multiple times. In contrast, the arch devices disclosed herein may provide the final impression with teeth position information and bite registration in just one dental office visit. The methods disclosed herein combines (1) preliminary impressions, (2) border molding and final impressions, (3) occlusal rim teeth position recording, (4) bite registration and (5) teeth try-in in one dental visit.

The arch devices and the method disclosed can also let the devices be turned into dentures in one dental visit.

Provided herein, in one aspect, is the combination of a stiff stock tray and a moldable material. The stock tray can be in different sizes to fit different sizes of subject’s mouth. The stock tray can also be separated into two or more pieces easily according to the need of the subject’s mouth by breaking the breakable strip(s) between the arch base and the teeth or within the arch base using hands or pliers or cutting with tools. The stock tray comprises a tissue side and a teeth side. The tissue side is facing the subject’s arch. It has retention holes or retention structures to help hold the moldable materials in place. The teeth side is on the opposite side of the tissue side. The teeth side may have a plurality of teeth. The moldable material is used to fill the void between the stock tray and the patient’s arch, and to form the denture base and border. In some embodiments, the teeth on the stock tray are breakable at the breakable strip(s) between the teeth or between the arch base and the teeth. In some embodiments, some teeth on the stock tray are removed in order to provide holes for the corresponding remaining teeth of the subject to pass through. This feature allows the stock tray to be used for partial edentulous subject. Examples of such teeth with breakable strip(s) can be found in the disclosure of PCT/US2024/033179, the content of which is incorporated by reference in its entirety.

When the retention mechanism is a hollow frustum in a tooth and is in the shape of a smaller tooth (i.e., the hollow frustum is configured to enclose a smaller tooth of the subject), the tooth on the stock tray is just tooth-shaped shells. A single tooth or multiple connected teeth matching the size that is needed for a temporary crown or temporary bridge can be cut off from the stock tray and used as crown former or bridge former, respectively. Temporary crown material, which is a form of moldable material, can be used to reline the tooth or teeth to make a temporary crown or a temporary bridge.

The stock tray is made from polymers or polymers with fillers. The polymers may be plastics. In some embodiments, the polymers may be a (meth)acrylate polymer, epoxy, silicones, polyesters, polyurethanes, thiol-ene polymer, or other polymers. Suitable acrylate polymers may include urethane (meth)acrylate polymers, polyalkylene oxide di(meth)acrylate, alkane diol di(meth)acrylate, aliphatic (meth)acrylates, or silicone (meth)acrylate. In some embodiments, the polymers may include urethane (meth)acrylate polymers comprising of alkyl, polyalkylene, polyalkylene oxide, aryl, polycarbonate, polyester, polyamide, and combinations thereof. In some embodiments, the polymers may be polyoxymethylene (POM), polyphenylene sulfide (PPS), polyphenylsulfone (PPSU), polysulfone (PSU), polyetheretherketone (PEEK), polybutylene terephthalate (PBT), polyamide-imide (PAI), polyvinyl chloride (PVC), polycarbonate, polylactide, acrylic, phenolic, acrylonitrile butadiene, styrene, fiberglass, or nylon, or a combination thereof.

The stock trays can comprise plastics, for example, thermosetting plastics or thermoplastic having a melting temperature no less than 50 ºC, no less than 55 ºC, no less than 60 ºC, no less than 65 ºC, no less than 70 ºC, or no less than 75 ºC. The stock trays can be a combination of plastics and other materials as needed. The stock trays cannot be molded or deformed or softened lower than about 50 ºC, lower than about 55 ºC, lower than about 60 ºC, lower than about 65 ºC, lower than about 70 ºC, lower than about 75 ºC, lower than about 80 ºC, lower than about 85 ºC, lower than about 90 ºC, lower than about 95 ºC, lower than about 100 ºC, lower than about 105 ºC, or lower than about 110 ºC. The stock trays can be molded or deformed or softened at about 60 ºC, about 65 ºC, about 70 ºC, about 75 ºC, about 80 ºC, about 85 ºC, about 90 ºC, about 95 ºC, about 100 ºC, about 105 ºC, or about 110 ºC. The fillers may be glass, quartz, silica, zirconia oxide, alumina oxide, TiO₂ or a combination thereof.

In some embodiments, the stock trays can comprise thermoplastics. In some embodiments, the thermoplastics is a polymer prepared from a light curing resin comprising two or more substituted or unsubstituted (meth)acrylate monomers and a photoinitiator. In some embodiments, the stock trays can be made from the light curing resin by 3D printing using a digital light processing 3D printer (e.g., at 385-405 nm). In some embodiments, the light curing resin may comprises two or more of bisphenol A ethoxylate dimethacrylate (CAS No. 41637-38-1), diurethane dimethacrylate (CAS No. 72869-86-4), and trimethylolpropane trimethacrylate (CAS No. 3290-92-4). In some embodiments, the light curing resin may comprises about 40-60% w/w bisphenol A ethoxylate dimethacrylate, about 30-50% w/w diurethane dimethacrylate, and about 5-10% w/w trimethylolpropane trimethacrylate. In some embodiments, the light curing resin may comprises about 10-25% w/w bisphenol A ethoxylate dimethacrylate, about 25-50% w/w diurethane dimethacrylate, and about 25-50% w/w trimethylolpropane trimethacrylate. In some embodiments, the light curing resin may comprises about 25-50% w/w bisphenol A ethoxylate dimethacrylate, about 25-50% w/w diurethane dimethacrylate, and about 10-25% w/w trimethylolpropane trimethacrylate. In some embodiments, the photoinitiator is diphenyl(2,4,6-trimethylbenzoyl)phosphine oxide (CAS No. 75980-60-8). In some embodiments, the photoinitiator is about 1-3% w/w diphenyl(2,4,6-trimethylbenzoyl)phosphine oxide.

In some embodiments, pre-setup of denture teeth can be conducted to make the teeth linked together as one piece matching the shapes of the teeth of the stock trays at each. A retention hole is designed into the tissue side of some, if not all, teeth of the subject. The pre-setup can be digital setup of denture teeth or premade denture teeth.

### Stock Trays

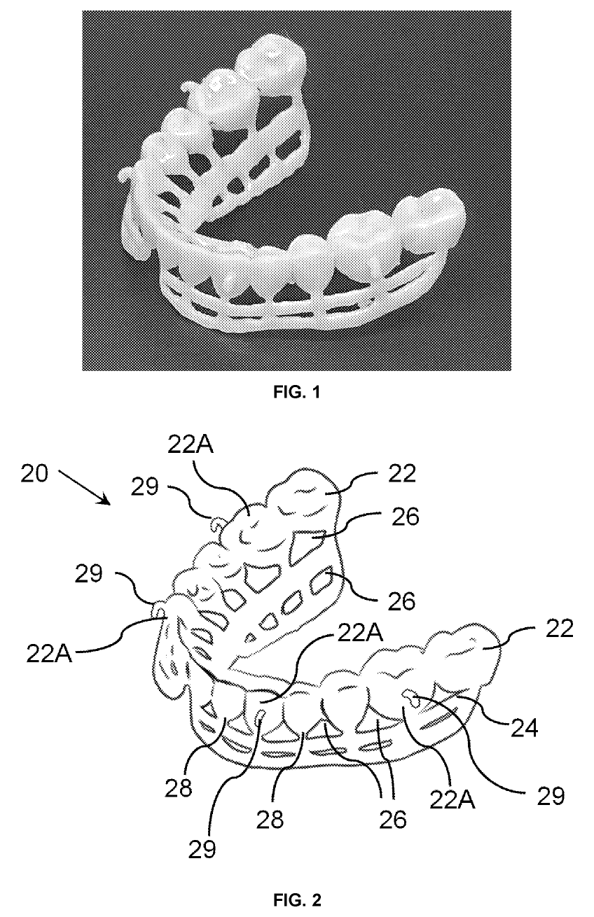

FIG. 1 shows a picture of an example lower stock tray. FIG. 2 shows an illustrative diagram of the example lower stock tray shown in FIG. 1. Turning now to FIG. 2 showing an example lower stock tray 20. The lower stock tray 20 may comprise a narrow arch/strip 24 on which supports a plurality of teeth 22. The plurality of teeth 22 comprises two or more teeth 22A. Each of the two or more teeth 22A comprises a hook 29. The hook 29 is configured to engage with a corresponding hook on a tooth of an upper stock tray when forming an assembly of the lower stock tray and the upper stock tray by connecting the two hooks with an elastomer, a rubber band, a strap, a ring, or a string, etc. In some embodiments, the hook 29 is configured to be breakable from the corresponding tooth 22A. The lower stock tray 20 may further comprise a plurality of retention mechanisms 26. The retention mechanisms 26 may spread over the narrow arch/strip 24 and around the teeth 22. In some embodiments the retention mechanism 26 can be in the shape of a smaller tooth (not shown). In some embodiments, the teeth 22 on the arch can be used as crown formers or bridge formers after broken off from the lower stock tray. In some embodiments, there may be a plurality of breakable strips between adjacent teeth 22 (not shown). In some embodiments, there may be a plurality of breakable strips 28 between a tooth 22 and the narrow arch/strip 24. By breaking the breakable strips 28, a tooth 22 or a plurality of teeth 22 may be removed from the narrow arch/strip 24 with which the tooth 22 is connected. Similarly, in some embodiments, portions of the narrow arch/strip 24 can be removed.

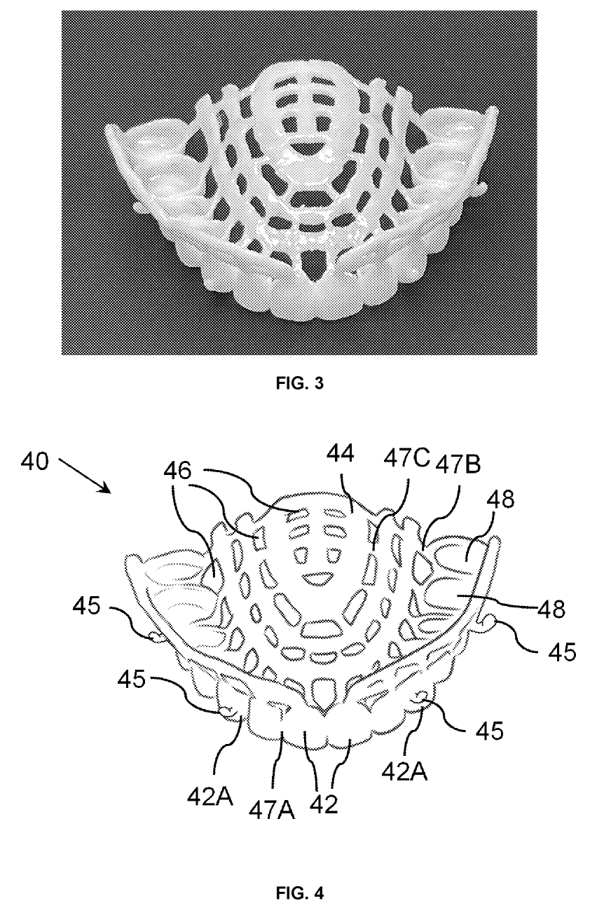

FIG. 3 shows a picture of an example upper stock tray. FIG. 4 shows an illustrative diagram of the example upper stock tray shown in FIG. 3. Turning now to FIG. 4, the upper stock tray 40 comprises a wider, raised arch/strip 44 on which supports a plurality of teeth 42. The plurality of teeth 42 comprises two or more teeth 42A. Each of the two or more teeth 42A comprises a hook 45. The hook 45 is configured to engage with a corresponding hook on a tooth of a lower stock tray when forming an assembly of the upper stock tray and the lower stock tray by connecting the two hooks with an elastomer, a rubber band, a strap, a ring, or a string etc. In some embodiment, the hook 45 is configured to be breakable from the corresponding tooth 42A. The upper stock tray 40 may further comprise a plurality of retention mechanisms 46 and 48. The retention mechanisms 46 may spread over the wider, raised arch/strip 44 and while the retention mechanisms 48 may be around the teeth 42. As shown in FIGS. 3 and 4, the retention mechanism 48 can be in the shape of a smaller tooth. Each retention mechanism 48 on a tooth 42 can be a hollow frustum in the tooth 42 on the stock tray 40. Each tooth 42 together with the corresponding hollow frustum 48 on the stock tray 40 can be a tooth-shaped hollow shell. The depth/width/dimension of the tooth-shaped hollow shell ranges from about 0.1 mm to about 3 mm. The depth/width/dimension of the tooth-shaped hollow shell can be about 0.1 mm, about 0.2 mm, about 0.3 mm, about 0.4 mm, about 0.5 mm, about 0.8 mm, about 1 mm, about 1.5 mm, about 2 mm, about 2.5 mm, or about 3 mm. The retention mechanism 48 when in the shape of a smaller tooth can be shaped as a shell with a thickness can be about 0.1 mm, about 0.2 mm, about 0.3 mm, about 0.4 mm, about 0.5 mm, about 0.8 mm, about 1.0 mm, about 1.5 mm, about 2.0 mm, about 2.5 mm, or about 3.0 mm. In some embodiments, the teeth on the arch can be used as crown formers or bridge formers after broken off from the stock tray. The teeth 42 may comprise anterior portion and posterior portions. Further, there may be a plurality of breakable strips 47A between adjacent teeth 42, and/or a plurality of breakable strips 47B between a tooth 42 and the wider, raised arch/strip 44, and/or a plurality of breakable strips 47C between adjacent sections of the wider, raised arch/strip 44. By breaking the breakable strips 43A and/or 43B and/or 43C, a tooth or a plurality of teeth 42 may be removed from the wider, raised arch/strip 44 with which the tooth 42 is connected, or portions of the wider, raised arch/strip 44 can be removed.

### Assembly

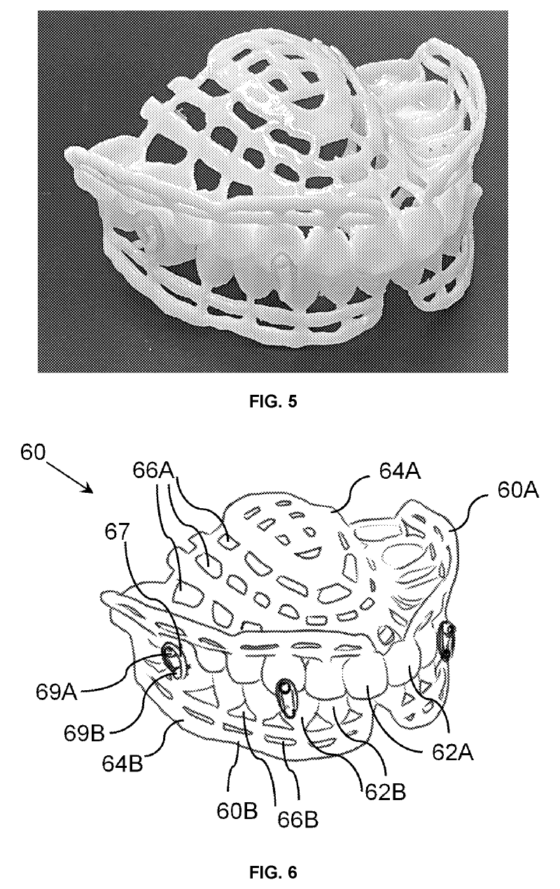

FIG. 5 shows a picture of an example assembly of an upper stock tray and a lower stock tray. FIG. 6 shows an illustrative diagram of the example assembly shown in FIG. 5. Turning now to FIG. 6, the assembly 60 comprises an upper stock tray 60A and a lower stock tray 60B. The upper stock tray 60A comprises a wider, raised arch/strip 64A on which supports a plurality of teeth 62A. The upper stock tray 60A may further comprise a plurality of retention mechanisms 66A. The retention mechanisms 66A may spread over the wider, raised arch/strip 64A. Each of two or more teeth 62A comprises a hook 69A. The lower stock tray 60B comprises a narrow strip 64B on which supports a plurality of teeth 62B. The lower stock tray 60B may further comprise a plurality of retention mechanisms 66B. The retention mechanisms 66B may spread over the narrow strip 64B. Each of two or more teeth 62B comprises a hook 69B. The upper stock tray 60A is placed on top of the lower stock tray 60B such that a hook 69A on the upper stock tray 60A is aligned with the corresponding hook 69B on the lower stock tray 60B. A rubber band 67 is placed on each pair of hook 69A and hook 69B. As shown in FIG. 6, there may be two or more rubber bands 67 tying up two or more pairs of hook 69A and hook 69B. In some embodiments, the rubber band can be replaced with a strap, a ring, or a string, etc. In some embodiments, the hook 69A is configured to be breakable from the corresponding tooth 62A, and the hook 69B is configured to be breakable from the corresponding tooth 62B. The assembly 60 can be placed in a patient’s mouth for further adjustment of the upper stock tray and/or the lower stock tray.

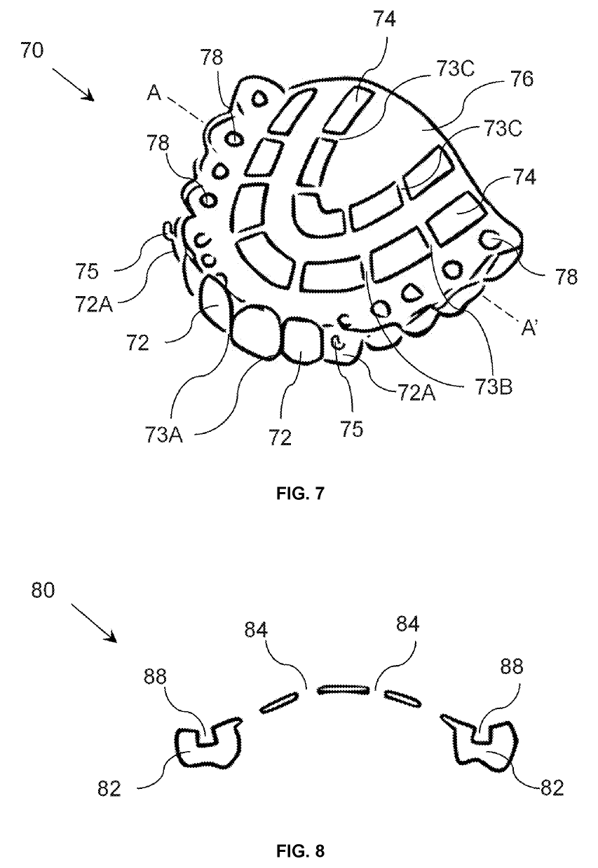

FIG. 7 shows an illustrative diagram of an example upper stock tray 70 which may comprise a wider, raised arch/strip 76 on which supports a plurality of teeth 72. The plurality of teeth 72 comprises two or more teeth 72A. Each of the two or more teeth 72A comprises a hook 75. The hook 75 is configured to engage with a corresponding hook on a tooth of a lower stock tray when forming an assembly of the upper stock tray and the lower stock tray via a rubber band or a string, etc. In some embodiments, the hook 75 is configured to be breakable from the corresponding tooth 72A. The upper stock tray 70 may further comprise a plurality of retention mechanisms 74 and 78. The retention mechanisms 74 and 78 may spread over the wider, raised arch/strip 76 and around the teeth 72. The retention mechanism 78 can be in the shape of a smaller tooth. Each retention mechanism 78 on a tooth 72 can be a hollow frustum in the tooth 72 on the stock tray 70. Each tooth 72 together with the corresponding hollow frustum 78 on the stock tray 70 can be a tooth-shaped hollow shell. The depth/width/dimension of the tooth-shaped hollow shell ranges from about 0.1 mm to about 3 mm. The depth/width/dimension of the tooth-shaped hollow shell can be about 0.1 mm, about 0.2 mm, about 0.3 mm, about 0.4 mm, about 0.5 mm, about 0.8 mm, about 1 mm, about 1.5 mm, about 2 mm, about 2.5 mm, or about 3 mm. The retention mechanism 78 when in the shape of a smaller tooth can be shaped as a shell with a thickness can be about 0.1 mm, about 0.2 mm, about 0.3 mm, about 0.4 mm, about 0.5 mm, about 0.8 mm, about 1.0 mm, about 1.5 mm, about 2.0 mm, about 2.5 mm, or about 3.0 mm. In some embodiments, the teeth on the arch can be used as crown formers or bridge formers after broken off from the stock tray. The teeth 72 may comprise anterior portion and posterior portions. Further, there may be a plurality of breakable strips 73A between adjacent teeth 72, and/or a plurality of breakable strips 73B between a tooth 72 and the wider, raised arch/strip 76, and/or a plurality of breakable strips 73C between adjacent sections of the wider, raised arch/strip 76. By breaking the breakable strips 73A and/or 73B and/or 73C, a tooth or a plurality of teeth 72 may be removed from the wider, raised arch/strip 76 with which the tooth 72 is connected, or portions of the wider, raised arch/strip 76 can be removed. Along the axis AA’ in FIG. 7 is a vertical plane relative to the upper stock tray 70, which provides a section view in FIG. 8.

Section view in FIG. 8 shows two teeth 82, each comprising a retention mechanism 88. The retention mechanism 88 is a hollow frustum. Further, the raised arch/strip comprises a plurality of retention mechanisms 84.

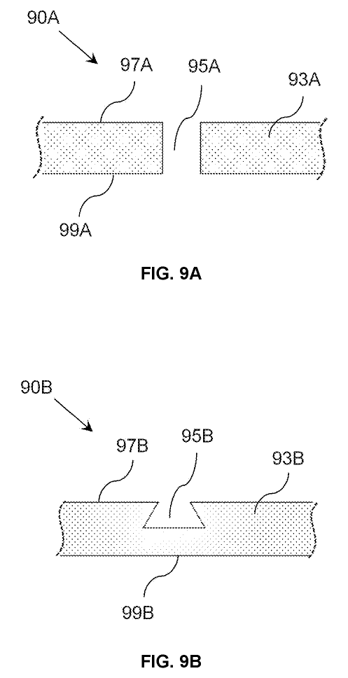

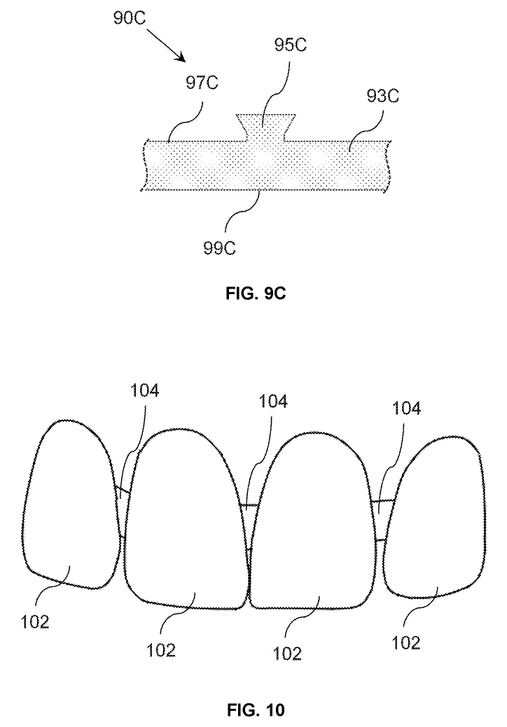

FIGS. 9A-9C further illustrate different designs for the retention mechanism which is configured to engage with the moldable material, especially after the moldable material is polymerized. The polymerized moldable material may form bonds with the surfaces of the retention mechanism. For example, FIG. 9A shows a retention mechanism 90A which comprises a cut-through hole 95A in the arch/strip/tooth 93A. The stock tray comprises a first surface 97A and a second surface 99A. The hole 95A can be in any shape, regular or irregular. Moldable material can pass through the hole and, after polymerization, form a “plug” that hold the polymerized moldable material in place. FIG. 9B shows a retention mechanism 90B which comprises a hollow frustum 95B in the arch/strip/tooth 93B on a first surface 97B of the stock tray. The stock tray comprises a first surface 97B and a second surface 99B. The frustum can be in any shape, regular or irregular, including but not limited to: conical frustum, square frustum, pentagonal frustum, pyramid frustum, triangular frustum, etc. Moldable material can fill the void of the hollow frustum and, after polymerization, form a “plug” or a “key in the lock” that hold the polymerized moldable material in place. The opening mouth can be the bigger mouth or the smaller mouth of the frustum. FIG. 9C shows a retention mechanism 90C which comprises a protrusion 95C on top of the arch/strip/tooth 93C on a first surface 97C of the stock tray. The stock tray comprises a first surface 97C and a second surface 99C. The protrusion can be in any shape, regular or irregular. As shown in FIG. 9C, the protrusion can be a frustum. The frustum can be in any shape, regular or irregular, including but not limited to: conical frustum, square frustum, pentagonal frustum, pyramid frustum, triangular frustum, etc. Moldable material can surround the protrusion 95C and solidify, thereby allowing the protrusion as a “nail” into the polymerized moldable material to restrict the movement thereof. When the moldable material surrounding the protrusion polymerized, the polymerized moldable material can engage with the protrusion and hold the polymerized material in place. The retention mechanisms can create resistance when the moldable material (whether before or after polymerization) is pushed away from the stock tray.

FIG. 10 further illustrates example breakable strips between adjacent teeth. As shown in FIG. 10, there is a plurality of teeth 102. There is a plurality of breakable strips 104 between adjacent teeth 102.

### Use of the Stock Trays and the Assembly

In one aspect of the present disclosure, provided herein is an arch device for a denture, comprising: (a) a stock tray comprising a polymeric material, the stock tray comprising: a first surface configured to face a dental arch, a second surface comprising two or more teeth, each of at least two of the two or more teeth comprising a hook; and (b) a moldable material disposed on the first surface, wherein the moldable material is configured to fill a void between the stock tray and the dental arch, and wherein the moldable material is curable upon a stimulus or is configured to become rigid material over time. Corresponding hooks on the upper stock tray and the lower stock tray, respectively, can form an assembly by being tied together via an elastomer, a rubber band, a strap, a ring, or a string, etc. The assembly of the present disclosure can be placed into a patient’s mouth together with other disclosure materials, such as, for example, moldable materials. In some embodiments, the hooks are configured to be breakable. In some embodiments, the hooks are broken and removed to the rest of the stock tray.

In some embodiments, the arch device comprises an upper arch device and a lower arch device. In some embodiments, the arch device comprises an upper arch device. In some embodiments, the arch device comprises a lower arch device. In some embodiments, the denture is full denture. In some embodiments, the denture is partial denture. In some embodiments, the denture is temporary denture. In some embodiments, the denture is permanent denture. In some embodiments, the polymeric material is plastics. In some embodiments, the polymeric material is thermosetting plastics.

In some embodiments, the moldable material allows the stock tray to be placed at the desired position relative to the corresponding arch of the subject, and to fill the void between the stock tray and the corresponding arch. The moldable material allows the stock tray to move within the patent’s mouth, and to provide the desired teeth position. After the desirable teeth position on the stock tray is found in the mouth of the subject, the moldable material is cured by receiving a stimulus or by self-cure or by chemical cure. The stimulus can be light or heat. The chemical cure can be the addition of polymerization initiators to the polymerizable materials such that the polymerizable materials are polymerized by a chain reaction. The stimulus can be applied when the stock tray remains in the subject’s mouth or is moved out of the subject’s mouth. More than one method of triggering the polymerization can be used. For example, a light cure stimulus is applied first, followed by a heat cure, or other combinations. The moldable material can be applied again if the cured stock tray still needs further adjustment. The cured stock tray can be post-modified to remove part of the cured resin if needed.

In some embodiments, the moldable material is curable upon a stimulus. In some embodiments, the moldable material is light curing resin composite or heat-curing resin composite. In some embodiments, the moldable material is light curing resin composite, and the stimulus is light. In some embodiments, the moldable material is heat curing resin composite, and the stimulus is heat. In some embodiments, the heat-curing resin composite comprises thermo-polymerizable acrylic resin. In some embodiments, the moldable material is self curing resin composite, and the stimulus is time. In some embodiments, the moldable material is chemical curing resin composite, and the stimulus is polymerization initiator. In some embodiments, the moldable material is thermoplastic material. Upon heating up, the material is moldable, and upon cooling down, the material is rigid.

In some embodiments, the light curing resin composite comprises polymerizable resin base, filler particles, or a combination thereof. In some embodiments, the polymerizable resin base comprises methacrylic acid (MA), methylmethacrylate (MMA), 2-hydroxyethyl-methacrylate (HEMA), triethyleneglycol dimethacrylate (TEGDMA), bisphenol-A-glycidyl dimethacrylate (BisGMA), ethoxylated bisphenol A dimethacrylate (Bis-EMA), bisphenol-A-propyl dimethacrylate (BisPMA), urethane-dimethacrylate (UEDMA or UDMA), or HEMA condensed with butanetetracarboxylic acid (TCB), or a combination thereof. In some embodiments, the polymerizable resin base comprises oxiranes, siloranes, oxetanes, spiro-orthocarbonate, spiroorthoester (SOEs), or spiroorthocarbonate, or a combination thereof. In some embodiments, the moldable material further comprises a photoinitiator. In some embodiments, the photoinitiator is trimethylbenzoyl-diphenylphosphine oxide (TPO), benzophenone, benzoyl peroxide (BPO), camphorquinone (CQ), 9,10-phenanthrenequinone (PQ), benzophenone (BP), 1-phenyl-1,2 propanedione (PPD), ethyl 4-dimethylaminobenzoate (EDAB), 9-(2,4,4,6-trimethylbenzoyl)-9-oxytho-9-phospha-fluorene (TMBOPF), or 9-(p-toluyl)-9-oxytho-9-phosphafluorene (TOPF), glycerol dimethacrylate (GDMA), or dodecanediol dimethacrylate (D3MA), or a combination thereof. The fillers may be glass, quartz, silica, zirconia oxide, alumina oxide, TiO2 or a combination thereof.

In some embodiments, the light curing resin for the moldable material is a kneadable paste comprising two or more substituted methacrylate, Vaseline, fillers, and a photoinitiator. Examples include Custom Light Cure Tray Material Light Cure Pink (Meta Dental Corp, Glendale, NY 11385) or Custom Tray Material Light Cure Pink 2 mm (Meta Dental Corp, Glendale, NY 11385). In some embodiments, the moldable material or impression material can comprise polyvinyl siloxane (PVS), such as hydroxyl terminated polysiloxane, and fillers (to control viscosity), and an accelerator, such as, divinylpolysiloxane prepolymers (crosslinking agent), chloroplatinic acid (catalyst), etc. Examples include Splash! (DenMat, Lompoc, CA 93436), Splash Max (DenMat, Lompoc, CA 93436), and Genie VPS (Sultran Healthcare, York, PA 17404). Additional examples of dental impression materials can be found at Gupta R, Brizuela M. Dental Impression Materials. [Updated 2023 Mar 19]. In: StatPearls [Internet]. Treasure Island (FL): StatPearls Publishing; 2025 Jan-. Available from: www.ncbi.nlm.nih.gov/books/NBK574496/.

In some embodiments, the impression material is used to copy the teeth and surrounding oral structures by creating a dental impression. In some embodiments, the impression material can be for primary impressions, e.g., alginate, impression compound, elastomeric putty. In some embodiments, the impression material can be for secondary impressions, e.g., light body elastomers and zinc oxide eugenol. In some embodiments, the impression material is chemically irreversible, e.g., alginate, impression plaster, elastomeric impression materials. In some embodiments, the impression material after setting in the oral cavity is rigid, e.g., impression compound, zinc oxide eugenol, impression plaster, impression waxes. In some embodiments, the impression material after setting in the oral cavity is elastic, e.g., alginate, agar, polysulfides, addition and condensation silicones, polyether. In some embodiments, the impression material is Zinc Oxide eugenol impression material (impression paste). In some embodiments, the impression material is alginate. In some embodiments, the impression material is agar. In some embodiments, the impression material is elastomeric impression material, such as, for example, addition silicone, also known as polyvinyl siloxanes (PVS), condensation silicone, polyether, and polysulfide. In some embodiments, the impression material is addition silicone. In some embodiments, the impression material is polyether. In some embodiments, the impression material is polysulfide. In some embodiments, the impression material is condensation silicone. In some embodiments, the opposing teeth on the paired maxillary stock tray and mandibular stock tray, respectively, are configured to inter-cuspated with each other. In some embodiments, this inter-cuspated configuration of opposing teeth can be further secured by tying a pair of opposing teeth comprising hooks with an elastomer, a rubber band, a strap, a ring, or a string, etc., or by simply hand holding the stock trays.

In some embodiments, the arch device disclosed herein is provided for fabrication of a temporary denture, by doing hard-relining or soft-relining the tissue side of custom tray with low viscosity relining material. In some embodiments, the arch device disclosed herein is provided for fabrication of a permanent denture, by doing hard-relining the tissue side of custom tray with low viscosity relining material.

Soft reline materials for dental use may comprise polyethylmethacrylate monomers, zinc undecylenate, plasticized ethyl methacrylate, silicone polymers, silicone, silicone-based materials, or vinyl silicone.

Hard reline materials for dental use may be resin composite comprises polymerizable resin base, filler particles, or a combination thereof. In some embodiments, the polymerizable resin base comprises methacrylic acid (MA), methylmethacrylate (MMA), 2-hydroxyethyl-methacrylate (HEMA), triethyleneglycol dimethacrylate (TEGDMA), bisphenol-A-glycidyl dimethacrylate (BisGMA), ethoxylated bisphenol A dimethacrylate (Bis-EMA), bisphenol-A-propyl dimethacrylate (BisPMA), urethane-dimethacrylate (UEDMA or UDMA), poly(ethyl methacrylate) (PEMA), or HEMA condensed with butanetetracarboxylic acid (TCB), or a combination thereof. In some embodiments, the polymerizable resin base comprises oxiranes, siloranes, oxetanes, spiro-orthocarbonate, spiroorthoester (SOEs), or spiroorthocarbonate, or a combination thereof. In some embodiments, the polymerizable resin further comprises a photoinitiator. In some embodiments, the photoinitiator is trimethylbenzoyl-diphenylphosphine oxide (TPO), benzophenone, benzoyl peroxide (BPO), camphorquinone (CQ), 9,10-phenanthrenequinone (PQ), benzophenone (BP), 1-phenyl-1,2 propanedione (PPD), ethyl 4-dimethylaminobenzoate (EDAB), 9-(2,4,4,6-trimethylbenzoyl)-9-oxytho-9-phosphafluorene (TMBOPF), or 9-(p-tolyl)-9-oxytho-9-phosphafluorene (TOPF), glycerol dimethacrylate (GDMA), or dodecanediol dimethacrylate (D3MA), polymethacrylate, ethyl methacrylate, ethyl methacrylate acrylic resin, or poly(ethyl methacrylate) (PEMA), or a combination thereof. The fillers may be glass, quartz, silica, zirconia oxide, alumina oxide, TiO2 or a combination thereof. The relined surface can also be used as final impression and scanned and sent to lab. In some embodiments, the arch device disclosed herein is provided to help make implant surgical guide.

In some embodiments, scan the denture supporting tissue in the mouth. Scan the custom tray or final impression with the corrected border. Stitch together the overlapping areas from the two scans. Keep the denture base area from the intraoral tissue scan and the border area from the custom tray scan or final impression. Incorporate the two scans into a more accurate image containing both the denture base and border.

In some embodiments, scan the denture supporting tissue and the subject’s remaining teeth in the mouth. Scan the custom tray or final impression with the corrected border. Stitch together the overlapping areas from the two scans. Keep the denture base area and the subject’s remaining teeth from the intraoral tissue scan and the border area from the custom tray scan or final impression. Incorporate the two scans into a more accurate image containing both the denture base and border.

In some embodiments, each of the stock trays with hooks can be made and used according to the disclosure of PCT/US2024/033179, the content of which is incorporated by reference in its entirety.

### Example 1. Denture Workflow Using a Stock Tray with Hooks

Step 1: Record preset vertical dimension of occlusion (VDO) for a subject (e.g., a patient) with a measuring device. The measuring device can be the multi-purpose device disclosed in PCT/US2024/033179, the content of which is incorporated by reference in its entirety)
   Determine a proper VDO.
Step 2: Select and modify the stock tray
   Use the measuring device and select the correct pair of maxillary and mandibular stock trays for the subject. Each pair of the maxillary stock tray and mandibular stock trays comprise two or more teeth that have hooks, the teeth can inter-cuspated together forming nice occlusion.
   Make sure that when the patient bite into centric relation at the preset VDO and the maxillary and mandibular teeth are positioned correctly in the mouth with the correct intercupation and, there is no tissue impingement from the trays.
   Adapt the stock trays using its thermoplastic and trimmable properties if necessary.
Step 3: Conduct maxillary teeth position collection and final impression.
   Generate maxillary custom tray with correct teeth positions
   Apply moldable material to intaglio the surface of the maxillary stock trays.
   Seat the maxillary stock trays and align:
      a. the midline;
      b. the horizontal plane; and
      c. the vertical tooth position and the sagittal tooth position.
   Allow the materials to set, thereby creating the maxillary customer tray with the correct teeth position.
Conduct maxillary final impression
   Perform border molding.
   Take final impression such that the maxillary stock tray comprises final impression with correct teeth positions.
Step 4: Conduct mandibular teeth position, jaw relationship collection and final impression.
Conduct tray adaptation
   Modify the mandibular stock tray using its thermoplastic and trimmable properties if necessary to allow:
      a. when maxillary final impression is seated completely, and maxillary teeth and mandibular teeth are inter-cuspated correctly, the subject can bite into centric relation at preset VDO without tissue impingement.
   Create a mandibular custom tray from the adapted stock tray and moldable material to precisely capture mandibular teeth positions and jaw relationships.
   Option A (with adequate mouth opening):
      a. Secure the maxillary stock tray with a final impression and correct teeth position and the mandibular stock tray together by tying each pair of the corresponding hooks on the teeth on the maxillary stock tray and mandibular stock trays with elastomers. Other choices, such as, for example, a rubber band, a strap, a ring, or a string, may also tie the pair of the corresponding hooks. The teeth from maxillary final impression and mandibular stock tray will inter-cuspated together and form nice bite relationship.
      b. Apply the moldable material to the mandibular stock tray.
      c. Seat the maxillary final impression in the subject’s mouth completely together with the mandibular stock tray.
      d. Guide the subject to close in centric relation at preset VDO.
   Option B (with limited mouth opening):
      a. Seat the maxillary final impression with correct teeth position in the mouth completely first
      b. Apply the moldable material to the mandibular stock tray. Secure mandibular tray in the mouth against maxillary tray with their teeth interdigitate correctly by a hand or with elastomers on the hooks, or with other choices, like a rubber band, a strap, a ring, or a string on the hooks.
      c. Guide the subject to close in centric relation at preset VDO.
   After the moldable material is set, a mandibular custom tray with the correct teeth position and jaw relationship is obtained.
Conduct final impression
   perform border molding on the custom tray
   Take the final impression, thereby the mandibular final impression comprises the correct teeth position and the correct jaw relationship.
Step 5: Conduct evaluation and finalization.
   Make clinical assessment (which can be functioned as a denture try-in visit)
      Verify the following:
         a. aesthetic;
         b. the centric relation; and
         c. VDO of the final impressions with teeth.
      Make necessary adjustments.
Step 6: Conduct lab submission. Complete and submit the following:
   a digital workflow comprising:
      scan of both final impressions;
      scan of bite registration; and
      supplemental arch scan if needed.
   a traditional workflow comprising:
      physical impression and bite registration.

Bite registration material can comprise vinyl polysiloxane. An example of the bite registration material is Correct Quick Bite Material Impression Material (Pentron Clinical, Orange, CA 92867).

### Embodiments

Embodiment 1. A stock tray comprising a polymeric material, wherein:
   the stock tray comprises an arch base comprising:
      a first surface configured to face a dental arch, and
      a second surface comprising two or more teeth positioned on a peripheral of the arch base;
   the arch base, the two or more teeth, or both, comprise one or more retention mechanisms,
   the two or more teeth comprise a first tooth and a second tooth,
   the first tooth comprises a first hook, and
   the second tooth comprises a second hook.
Embodiment 2. The stock tray of Embodiment 1, further comprising a plurality of breakable strips between adjacent teeth of the two or more teeth, between a tooth of the two or more teeth and the arch base, or between one section of the arch base and an adjacent section of the arch base.
Embodiment 3. The stock tray of Embodiment 1, wherein the stock tray is an upper stock tray, wherein:
   the upper stock tray comprises a first arch base comprising:
      a first surface configured to face an upper dental arch, and
      a second surface comprising two or more upper teeth positioned on a peripheral of the first arch base,
   the first arch base, the two or more upper teeth, or both, comprise one or more upper retention mechanisms,
   the two or more upper teeth comprise a first upper tooth and a second upper tooth,
   the first upper tooth comprises a first upper hook, and
   the second upper tooth comprises a second upper hook.
Embodiment 4. The stock tray of Embodiment 1, wherein the stock tray is a lower stock tray, wherein:
   the lower stock tray comprises a second arch base comprising:
      a third surface configured to face a lower dental arch; and
      a fourth surface comprising two or more lower teeth positioned on a peripheral of the second arch base;
   the second arch base, the two or more lower teeth, or both, comprise one or more lower retention mechanisms,
   the two or more lower teeth comprise a first lower tooth and a second lower tooth,
   the first lower tooth comprises a first lower hook, and
   the second lower tooth comprises a second lower hook.
Embodiment 5. The stock tray of any one of Embodiments 1-4, wherein the polymeric material is plastics.
Embodiment 6. The stock tray of Embodiment 5, wherein the polymeric material is thermosetting plastics.
Embodiment 7. The stock tray of any one of Embodiments 1-4, wherein the polymeric material is thermoplastics with glass transition temperature of at least 100 ºC.
Embodiment 8. The stock tray of any one of Embodiments 1-7, wherein the polymeric material comprises polyoxymethylene (POM), polyphenylene sulfide (PPS), polyphenylsulfone (PPSU), polysulfone (PSU), polyetheretherketone (PEEK), polybutylene terephthalate (PBT), polyamide-imide (PAI), polyvinyl chloride (PVC), polycarbonate, polylactide, acrylic, phenolic, acrylonitrile butadiene, styrene, fiberglass, or nylon, or a combination thereof.
Embodiment 9. The stock tray of any one of Embodiments 1-7, wherein the polymeric material comprises (meth)acrylate polymer, epoxy, silicone, polyester, polyurethane, or thiol-ene polymer.
Embodiment 10. The stock tray of any one of Embodiments 1-7, wherein the polymeric material comprises urethane (meth)acrylate polymer, polyalkylene oxide di(meth)acrylate, alkane diol di(meth)acrylate, aliphatic (meth)acrylate, or silicone (meth)acrylate.
Embodiment 11. The stock tray of any one of Embodiments 1-7, wherein the polymeric material comprises urethane (meth)acrylate polymer comprising an alkyl group, a polyalkylene group, a polyalkylene oxide group, an aryl group, a polycarbonate group, a polyester group, or a polyamide group, or a combination thereof.
Embodiment 12. The stock tray of any one of Embodiments 8-11, further comprising a filler.
Embodiment 13. The stock tray of Embodiment 12, wherein the filler is independently glass, quartz, silica, zirconia oxide, alumina oxide, TiO₂ or a combination thereof.
Embodiment 14. The stock tray of any one of Embodiments 1-13, wherein the one or more retention mechanisms comprise a hole, a hollow frustum, a protrusion, or a combination thereof.
Embodiment 15. The stock tray of Embodiments 14, wherein the one or more retention mechanisms comprise the hole, and wherein the hole is on the arch base or the one or more teeth.
Embodiment 16. The stock tray of Embodiment 14 or Embodiment 15, wherein the one or more retention mechanisms comprise the hollow frustum on the first surface of the stock tray, and wherein the hollow frustum is on the arch base or the one or more teeth.
Embodiment 17. The stock tray of Embodiment 16, wherein the one or more retention mechanisms comprises one or more hollow frustum, where each of the one or more hollow frustum is part of a tooth of one or more teeth on the stock tray, where each of the one or more hollow frustum together with the corresponding tooth of the one or more teeth on the stock tray is a tooth-shaped hollow shell.
Embodiment 18. The stock tray of any one of Embodiments 14-17, wherein the one or more retention mechanisms comprise the protrusion on the first surface of the stock tray, and wherein the protrusion is on the arch base or the one or more teeth.
Embodiment 19. The stock tray of any one of Embodiments 1-18, wherein at least one breakable strip of the plurality of breakable strips is between the adjacent teeth.
Embodiment 20. The stock tray of any one of Embodiments 1-19, wherein at least one breakable strip of the plurality of breakable strips is between the tooth and the arch base.
Embodiment 21. The stock tray of any one of Embodiments 1-20, wherein at least one breakable strip of the plurality of breakable strips is between the one section of the arch base and the adjacent section of the arch base.
Embodiment 22. The stock tray of any one of Embodiments 1-21, wherein each of the first hook, the second hook, the first upper hook, the second upper hook, the first lower hook, and the second lower hook is configured to be breakable from the first tooth, the second tooth, the first upper tooth, the second upper tooth, the first lower tooth, and the second lower tooth, respectively.
Embodiment 23. An assembly comprising an upper stock tray and a lower stock tray, wherein:
   the upper stock tray comprises a first arch base comprising:
      a first surface configured to face an upper dental arch, and
      a second surface comprising two or more upper teeth positioned on a peripheral of the first arch base,
   the first arch base, the two or more upper teeth, or both, comprise one or more upper retention mechanisms,
   the two or more upper teeth comprise a first upper tooth and a second upper tooth,
   the first upper tooth comprises a first upper hook,
   the second upper tooth comprises a second upper hook,
   the lower stock tray comprises a second arch base comprising:
      a third surface configured to face a lower dental arch; and
      a fourth surface comprising two or more lower teeth positioned on a peripheral of the second arch base;
   the second arch base, the two or more lower teeth, or both, comprise one or more lower retention mechanisms,
   the two or more lower teeth comprise a first lower tooth and a second lower tooth,
   the first lower tooth comprises a first lower hook,
   the second lower tooth comprises a second lower hook,
   the first upper hook and the first lower hook is tied with a first elastomer, a first rubber band, a first strap, a first ring, or a first string, and
   the second upper hook and the second lower hook are tied with a second elastomer, a second rubber band, a second strap, a second ring, or a second string.
Embodiment 24. The assembly of Embodiment 23, wherein:
   the two or more upper teeth comprise an additional upper tooth,
   the additional upper tooth comprises an additional upper hook,
   the two or more lower teeth comprise an additional lower tooth,
   the additional lower tooth comprises an additional lower hook, and
   the additional upper hook and the additional lower hook are tied with an additional elastomer, an additional rubber band, an additional strap, an additional ring, or an additional string
Embodiment 25. The assembly of Embodiment 23, wherein:
   the two or more upper teeth further comprise a third upper tooth and a fourth upper tooth,
   the third upper tooth comprises a third upper hook,
   the fourth upper tooth comprises a fourth upper hook,
   the two or more lower teeth further comprise a third lower tooth and a fourth lower tooth,
   the third lower tooth comprises a third lower hook,
   the fourth lower tooth comprises a fourth lower hook,
   the third upper hook and the third lower hook is tied with a third elastomer, a third rubber band, a third strap, a third ring, or a third string, and
   the fourth upper hook and the fourth lower hook is tied with a fourth elastomer, a fourth rubber band, a fourth strap, a fourth ring, or a fourth string.
Embodiment 26. The assembly of any one of the Embodiments 23-25, wherein each of the first upper hook, the second upper hook, the additional upper hook, the third upper hook, the fourth upper hook, the first lower hook, the second lower hook, the additional lower hook, the third lower hook, and the fourth lower hook is configured to be breakable from the first upper tooth, the second upper tooth, the additional upper tooth, the third upper tooth, the fourth upper tooth, the first lower tooth, the second lower tooth, the additional lower tooth, the third lower tooth, and the fourth lower tooth, respectively.
Embodiment 27. A method for forming an arch device for a subject, comprising:
   (a) providing a pair of stock trays of any one of Embodiments 1-22, wherein the pair of stock trays comprise a maxillary stock tray and a mandibular stock tray;
   (b) placing a first portion of a moldable material on a first surface of the maxillary stock tray, and spreading the first portion of the moldable material over at least a part of the first surface;
   (c) adjusting the maxillary stock tray in a mouth of the subject; and
   (d) curing the first portion of the moldable material on the maxillary stock tray, thereby making a maxillary custom tray which also record the correct teeth position;
   (e) using the maxillary custom tray to get final impression with the correct teeth position,
   (e) adjusting the mandibular stock tray;
   (f) secure the maxillary final impression and the mandibular stock tray together with an elastomer, a rubber band, a strap, a ring, or a string or a hand;
   (g) placing a second portion of the moldable material on a second surface of the mandibular stock tray, and spreading the second portion of the moldable material over at least a part of the second surface;
   (h) seating the maxillary final impression tied with the mandibular stock tray in the mouth of the subject completely;
   (j) guide the subject to close into centric relation at preset VDO; and
   (k) curing the second portion of the moldable material on the mandibular stock tray, thereby forming the mandibular custom tray with the teeth in the correct position and the correct jaw relationship.
Embodiment 28. The method of Embodiment 27, further comprising:
   (l) using the mandibular custom tray to get final impression with the correct mandibular teeth and jaw relationship.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following Embodiments define the scope of the invention and that methods and structures within the scope of these Embodiments and their equivalents be covered thereby.

1. A stock tray comprising a polymeric material, wherein:
the stock tray comprises an arch base comprising:
a first surface configured to face a dental arch, and
a second surface comprising two or more teeth positioned on a peripheral of the arch base;
the arch base, the two or more teeth, or both, comprise one or more retention mechanisms,
the two or more teeth comprise a first tooth and a second tooth,
the first tooth comprises a first hook, and
the second tooth comprises a second hook.

2. The stock tray of claim 1, further comprising a plurality of breakable strips between adjacent teeth of the two or more teeth, between a tooth of the two or more teeth and the arch base, or between one section of the arch base and an adjacent section of the arch base.

3. The stock tray of claim 1, wherein the stock tray is an upper stock tray,
wherein:
the upper stock tray comprises a first arch base comprising:
a first surface configured to face an upper dental arch, and
a second surface comprising two or more upper teeth positioned on a peripheral of the first arch base,
the first arch base, the two or more upper teeth, or both, comprise one or more upper retention mechanisms,
the two or more upper teeth comprise a first upper tooth and a second upper tooth,
the first upper tooth comprises a first upper hook, and
the second upper tooth comprises a second upper hook.

4. The stock tray of claim 1, wherein the stock tray is a lower stock tray, wherein:
the lower stock tray comprises a second arch base comprising:
a third surface configured to face a lower dental arch; and
a fourth surface comprising two or more lower teeth positioned on a peripheral of the second arch base;
the second arch base, the two or more lower teeth, or both, comprise one or more lower retention mechanisms,
the two or more lower teeth comprise a first lower tooth and a second lower tooth,
the first lower tooth comprises a first lower hook, and
the second lower tooth comprises a second lower hook.

5. The stock tray of claim 1, wherein the polymeric material is plastics, thermosetting plastics, or thermoplastics with glass transition temperature of at least 100 °C.

6. The stock tray of claim 1, wherein the polymeric material comprises:
(i) polyoxymethylene (POM), polyphenylene sulfide (PPS), polyphenylsulfone (PPSU), polysulfone (PSU), polyetheretherketone (PEEK), polybutylene terephthalate (PBT), polyamide-imide (PAI), polyvinyl chloride (PVC), polycarbonate, polylactide, acrylic, phenolic, acrylonitrile butadiene, styrene, fiberglass, or nylon, or a combination thereof; or
(ii) (meth)acrylate polymer, epoxy, silicone, polyester, polyurethane, or thiol-ene polymer; or
(iii) urethane (meth)acrylate polymer, polyalkylene oxide di(meth)acrylate, alkane diol di(meth)acrylate, aliphatic (meth)acrylate, or silicone (meth)acrylate; or
(iv) urethane (meth)acrylate polymer comprising an alkyl group, a polyalkylene group, a polyalkylene oxide group, an aryl group, a polycarbonate group, a polyester group, or a polyamide group, or a combination thereof.

7. The stock tray of claim 6, further comprising a filler, and the filler is independently glass, quartz, silica, zirconia oxide, alumina oxide, TiO₂ or a combination thereof.

8. The stock tray of claim 1, wherein the one or more retention mechanisms comprise a hole, a hollow frustum, a protrusion, or a combination thereof.

9. The stock tray of claims claim 8, wherein:
(i) the one or more retention mechanisms comprise the hole, and wherein the hole is on the arch base or the one or more teeth; or
(ii) the one or more retention mechanisms comprise the hollow frustum on the first surface of the stock tray, and wherein the hollow frustum is on the arch base or the one or more teeth; or
(iii) the one or more retention mechanisms comprises one or more hollow frustum, where each of the one or more hollow frustum is part of a tooth of one or more teeth on the stock tray, where each of the one or more hollow frustum together with the corresponding tooth of the one or more teeth on the stock tray is a tooth-shaped hollow shell; or
(iv) the one or more retention mechanisms comprise the protrusion on the first surface of the stock tray, and wherein the protrusion is on the arch base or the one or more teeth.

10. The stock tray of claim 1, wherein:
(i) at least one breakable strip of the plurality of breakable strips is between the adjacent teeth; or
(ii) at least one breakable strip of the plurality of breakable strips is between the tooth and the arch base; or
(iii) at least one breakable strip of the plurality of breakable strips is between the one section of the arch base and the adjacent section of the arch base.

11. The stock tray of claim 1, wherein each of the first hook, the second hook, the first upper hook, the second upper hook, the first lower hook, and the second lower hook is configured to be breakable from the first tooth, the second tooth, the first upper tooth, the second upper tooth, the first lower tooth, and the second lower tooth, respectively.

12. An assembly comprising an upper stock tray and a lower stock tray, wherein:
the upper stock tray comprises a first arch base comprising:
a first surface configured to face an upper dental arch, and
a second surface comprising two or more upper teeth positioned on a peripheral of the first arch base,
the first arch base, the two or more upper teeth, or both, comprise one or more upper retention mechanisms,
the two or more upper teeth comprise a first upper tooth and a second upper tooth,
the first upper tooth comprises a first upper hook,
the second upper tooth comprises a second upper hook,
the lower stock tray comprises a second arch base comprising:
a third surface configured to face a lower dental arch; and
a fourth surface comprising two or more lower teeth positioned on a peripheral of the second arch base;
the second arch base, the two or more lower teeth, or both, comprise one or more lower retention mechanisms,
the two or more lower teeth comprise a first lower tooth and a second lower tooth,
the first lower tooth comprises a first lower hook,
the second lower tooth comprises a second lower hook,
the first upper hook and the first lower hook is tied with a first elastomer, a first rubber band, a first strap, a first ring, or a first string, and
the second upper hook and the second lower hook are tied with a second elastomer, a second rubber band, a second strap, a second ring, or a second string.

13. The assembly of claim 12, wherein:
the two or more upper teeth comprise an additional upper tooth,
the additional upper tooth comprises an additional upper hook,
the two or more lower teeth comprise an additional lower tooth,
the additional lower tooth comprises an additional lower hook, and
the additional upper hook and the additional lower hook are tied with an additional elastomer, an additional rubber band, an additional strap, an additional ring, or an additional string.

14. The assembly of claim 12, wherein:
the two or more upper teeth further comprise a third upper tooth and a fourth upper tooth,
the third upper tooth comprises a third upper hook,
the fourth upper tooth comprises a fourth upper hook,
the two or more lower teeth further comprise a third lower tooth and a fourth lower tooth,
the third lower tooth comprises a third lower hook,
the fourth lower tooth comprises a fourth lower hook,
the third upper hook and the third lower hook is tied with a third elastomer, a third rubber band, a third strap, a third ring, or a third string, and
the fourth upper hook and the fourth lower hook is tied with a fourth elastomer, a fourth rubber band, a fourth strap, a fourth ring, or a fourth string.

15. The assembly of claim 12, wherein each of the first upper hook, the second upper hook, the additional upper hook, the third upper hook, the fourth upper hook, the first lower hook, the second lower hook, the additional lower hook, the third lower hook, and the fourth lower hook is configured to be breakable from the first upper tooth, the second upper tooth, the additional upper tooth, the third upper tooth, the fourth upper tooth, the first lower tooth, the second lower tooth, the additional lower tooth, the third lower tooth, and the fourth lower tooth, respectively.

16. A method for forming an arch device for a subject, comprising:
(a) providing a pair of stock trays of claim 1, wherein the pair of stock trays comprise a maxillary stock tray and a mandibular stock tray;
(b) placing a first portion of a moldable material on a first surface of the maxillary stock tray, and spreading the first portion of the moldable material over at least a part of the first surface;
(c) adjusting the maxillary stock tray in a mouth of the subject; and
(d) curing the first portion of the moldable material on the maxillary stock tray, thereby making a maxillary custom tray which also record the correct teeth position;
(e) using the maxillary custom tray to get final impression with the correct teeth position,
(e) adjusting the mandibular stock tray;
(f) secure the maxillary final impression and the mandibular stock tray together with an elastomer, a rubber band, a strap, a ring, or a string or a hand;
(g) placing a second portion of the moldable material on a second surface of the mandibular stock tray, and spreading the second portion of the moldable material over at least a part of the second surface;
(h) seating the maxillary final impression tied with the mandibular stock tray in the mouth of the subject completely;
(j) guide the subject to close into centric relation at preset VDO; and
(k) curing the second portion of the moldable material on the mandibular stock tray, thereby forming the mandibular custom tray with the teeth in the correct position and the correct jaw relationship.

17. The method of claim 16, further comprising:
(l) using the mandibular custom tray to get final impression with the correct mandibular teeth and jaw relationship.

18. A method for forming an arch device for a subject, comprising:
(a) providing the assembly of claim 12, wherein the pair of stock trays comprise the upper stock tray and the lower stock tray;
(b) placing a first portion of a moldable material on the first surface of the upper stock tray, and spreading the first portion of the moldable material over at least a part of the first surface;
(c) adjusting the upper stock tray in a mouth of the subject; and
(d) curing the first portion of the moldable material on the upper stock tray, thereby making a upper custom tray which also record the correct teeth position;
(e) using the upper custom tray to get final impression with the correct teeth position,
(e) adjusting the lower stock tray;
(f) secure the upper final impression and the lower stock tray together with an elastomer, a rubber band, a strap, a ring, or a string or a hand;
(g) placing a second portion of the moldable material on a second surface of the lower stock tray, and spreading the second portion of the moldable material over at least a part of the second surface;
(h) seating the upper final impression tied with the lower stock tray in the mouth of the subject completely;
(j) guide the subject to close into centric relation at preset VDO; and
(k) curing the second portion of the moldable material on the lower stock tray, thereby forming the lower custom tray with the teeth in the correct position and the correct jaw relationship.

19. The method of claim 18, further comprising:
(l) using the lower custom tray to get final impression with the correct lower teeth and jaw relationship.
